(19) United States
(12) Patent Application Publication
(10) Pub. No.: US 2007/0133790 A1
(43) Pub. Date: Jun. 14, 2007

(54) RANDOM NUMBER GENERATOR AND METHOD FOR GENERATING RANDOM NUMBER

(75) Inventors: Shao-Chang CHANG, Taipei City (TW); Kai-Cheung JUANG, Nantou City, Nantou County (TW); Wen-Yuan LIU, Taoyuan City, Taoyuan County (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: INDUSTRIAL TECHNOLOGY RESEARCH INSTITUTE, Chutung (TW)

(21) Appl. No.: 11/426,793

(22) Filed: Jun. 27, 2006

(30) Foreign Application Priority Data
Dec. 12, 2005 (TW) 094146632

(51) Int. Cl. H04L 9/00

(52) U.S. Cl. 380/46

(57) ABSTRACT

A random number circuit includes an oscillator capable of generating a clock signal including a sequence of clocks at a center frequency, the clock signal having a frequency offset from the center frequency, a reset circuitry capable of generating a reset signal indicating a transition from a first state to a second state, an initial value generator capable of generating an initial value, and a counter coupled to at least one of the oscillator, the reset circuitry, and the initial value generator and capable of receiving at least one of the clock signal, the reset signal, and the initial value, the counter capable of generating a random number, the random number being dependent on at least one of the frequency offset, a timing of the transition, and the initial value.

### BACKGROUND OF THE INVENTION

The present invention relates generally to a random number generating circuit, and more particularly, to a circuit for generating a seed number and a method for generating the seed number.

A random number generator refers to a computational or physical device for generating a sequence of numbers in a pattern that is not easily discernable, so that the sequence can be treated as being random. Random number generators may generally be divided into pseudo-random number generators and hardware random number generators. A pseudo-random number generator often includes software routines implementing algorithms instead of hardware devices for producing random numbers, which are not truly random outputs. Given the original state (seed state) of a pseudo-random number generator, and the implementation of the algorithm employed by the generator, the randum outputs produced by the pseudo-random number generator are predictable, i.e. not random. In other words, if two random number generators operating under the same algorithm are seeded with the same seed value, both generators will produce the same sequence of numbers. On the other hand, a hardware random number generator includes an apparatus or device for generating random numbers from a physical process that, in theory, is unpredictable. In the hardware random number generator, the seed value, which determines a sequence of numbers to be produced, is generally random.

### BRIEF SUMMARY OF THE INVENTION

Examples of the invention may provide a circuit and a method for generating a random seed value, which in turn may be used as a base for generating a sequence of random numbers.

Examples of the invention may provide a random number circuit that comprises an oscillator capable of generating a clock signal including a sequence of clocking pulses at a center frequency, the clock signal having a frequency offset from the center frequency, a reset circuitry capable of generating a reset signal indicating a transition from a first state to a second state, an initial value generator capable of generating an initial value, and a counter coupled to at least one of the oscillator, the reset circuitry, and the initial value generator and capable of receiving at least one of the clock signal, the reset signal, and the initial value, the counter capable of generating a random number, the random number being dependent on at least one of the frequency offset, a timing of the transition, and the initial value.

Examples of the invention may also provide a random number circuit that comprises a device capable of providing a first voltage, an oscillator capable of generating a clock signal including a sequence of clocking pulses at a center frequency, the clock signal having a frequency offset from the center frequency, a charge pump capable of generating a second voltage being an integer multiple of the first voltage, a reset circuitry capable of generating a reset signal, the reset signal transitioning from a first state to a second state once the second voltage reaches a predetermined voltage level, an initial value generator capable of generating an initial value, and a counter capable of counting the number of clocking pulses starting from the initial value in response to the clock signal, and generating a random number in response to the transitioning of the reset signal.

Some examples of the invention may also provide a random number circuit that comprises a first random number generator capable of generating a first random number comprising an oscillator capable of generating a clock signal including a sequence of clocking pulses, a reset circuitry capable of generating a reset signal indicating a transition from a first state to a second state, an initial value generator capable of generating an initial value, and a counter capable of generating the first random number in response to the clock signal, the reset signal and the initial value, and a second random number generator receiving the first random number capable of generating a second random number.

Examples of the invention may also provide a method for generating a random number that comprises providing a first voltage, generating a clock signal including a sequence of clocking pulses, generating a second voltage being an integer multiple of the first voltage, generating a reset signal including a first state and a second state, transitioning the reset signal from one of the first and second states to the other of the first and second states once the second voltage reaches a predetermined voltage level, generating an initial value, and counting the number of clocking pulses starting from the initial value in response to the clock signal, and generating the random number in response to the transitioning of the reset signal.

Examples of the invention may also provide a method for generating a random number that comprises generating a clock signal including a sequence of clocking pulses, generating a reset signal indicating a transition from a first state to a second state, generating an initial value, generating a first random number in response to the clock signal, the reset signal and the initial value, and generating a second random number using the first random number as a seed number.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples consistent with the invention. It should be understood, however, that the invention is not limited to the precise arrangements and instrumentalities shown.

In the drawings:

FIG. 1A is a block diagram of a random number generator consistent with an example of the invention;

FIG. 1B is a circuit diagram of a unit of an initial value generator illustrated in FIG. 1A for producing a random bit value;

FIG. 1C is a schematic timing diagram for the random number generator illustrated in FIG. 1A;

FIG. 2 is a flow diagram of a method for generating a random number consistent with an example of the invention;

FIG. 3A is a schematic block diagram of a radio frequency identification (“RFID”) device consistent with an example of the invention; and

FIG. 3B is a block diagram of a seed number generator of the RFID device illustrated in FIG. 3A.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like portions.

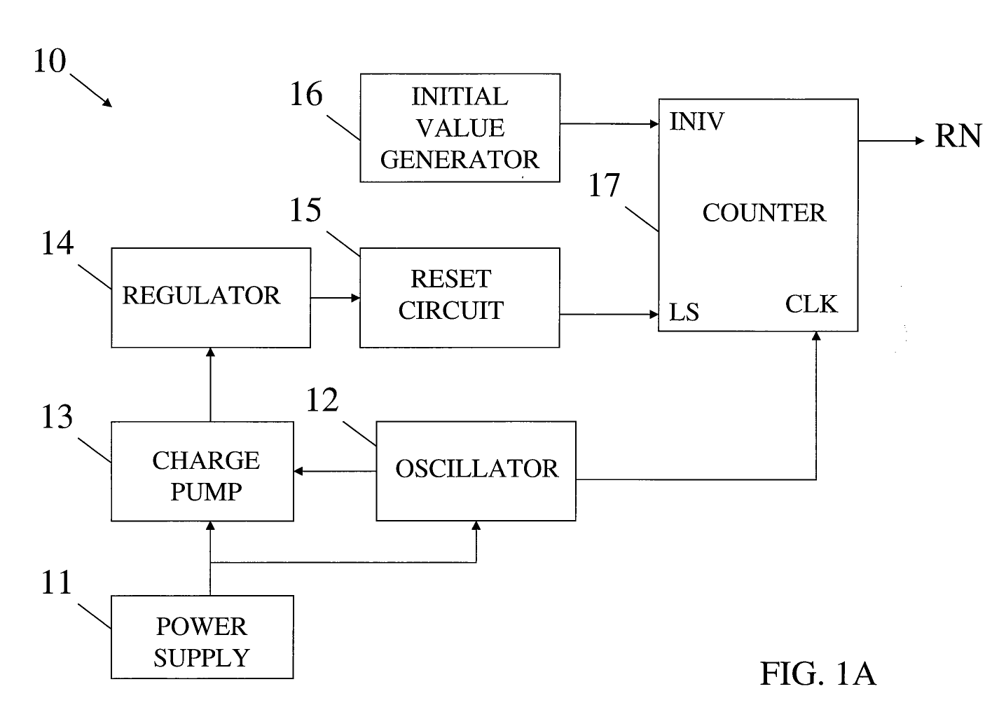

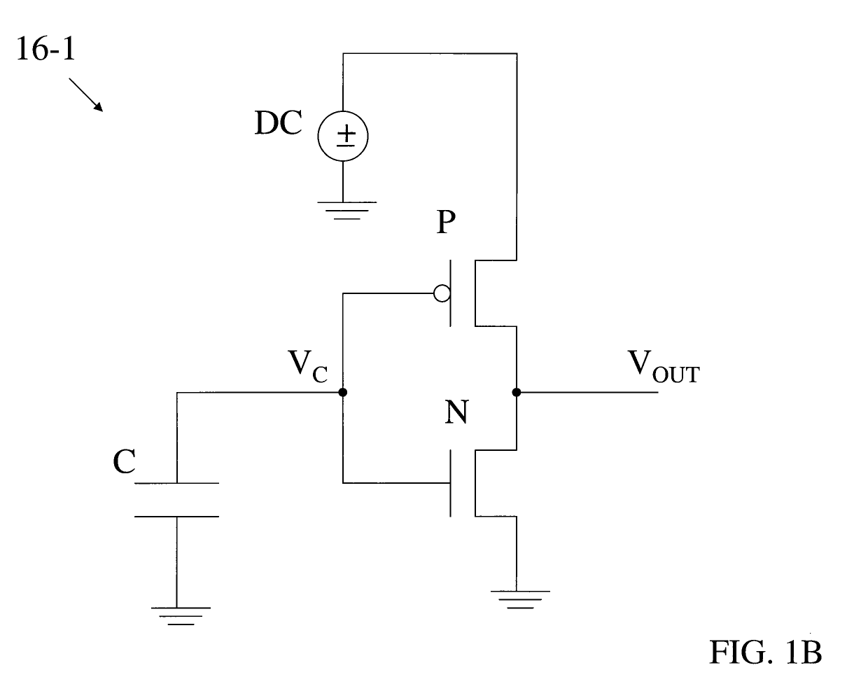

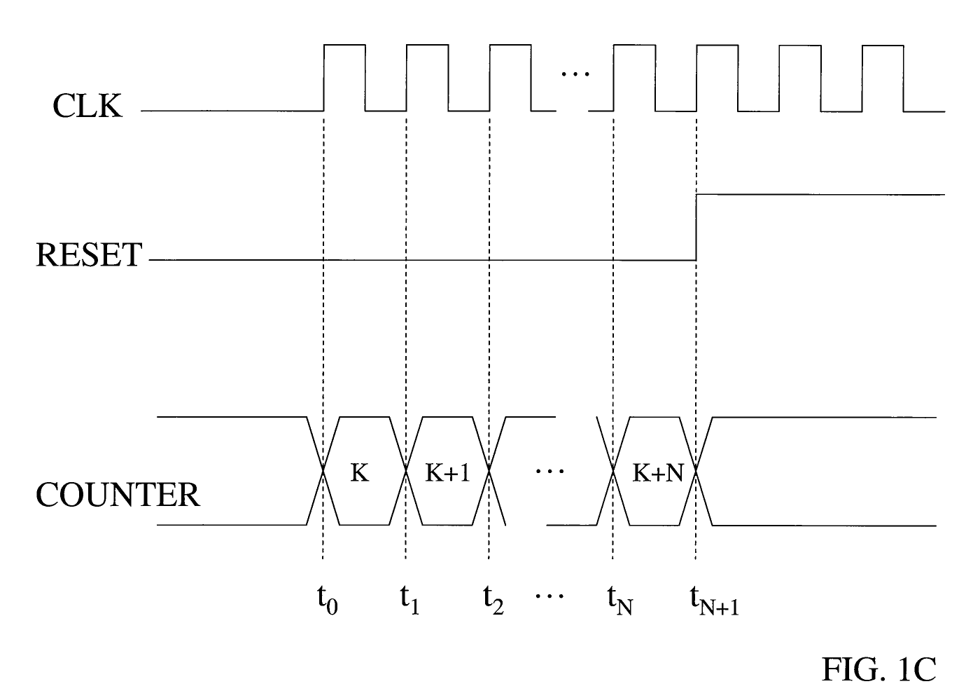

FIG. 1A is a block diagram of a random number generator 10 in accordance with one embodiment of the present invention. Referring to FIG. 1A, the random number generator 10 includes a power supply 11, an oscillator 12, a charge pump 13, a regulator 14, a reset circuit 15, an initial value generator 16 and a counter 17. The power supply 11 such as a battery provides a supply voltage sufficient to cause oscillation of the oscillator 12. Once oscillates, the oscillator 12 generates a clock signal to the charge pump 13 and the counter 17. In one example, the oscillator 12 includes a ring oscillator, which generates a clock signal at a center frequency of approximately 10 megahertz (MHz). As compared to other oscillators, the ring oscillator is less precise and may have a relatively high tolerance up to approximately 10% in the clock frequency, resulting in a frequency offset of 0.1 MHz from the center frequency. Such a high tolerance, however, helps increase the randomness of the random numbers generated.

The charge pump 13 includes but is not limited to a conventional switched capacitor multi-stage structure comprising a plurality of capacitors (not shown) and switches controlled under clocks of inverted phases. Specifically, the charge pump 13 adds voltages on capacitors charged by the supply voltage from the power supply 11 in response to the clock signal from the oscillator 12. The charge pump 13 provides an output voltage which is an integer multiple of the supply voltage. The regulator 14 regulates the output voltage from the charge pump with respect to a predetermined voltage level. In one example, a regulated charge pump is used to replace the charge pump 13 and the regulator 14. The regulated charge pump includes, for example, a voltage multiplier module to pull up the supply voltage provided from the power supply 11, and a regulator module to then maintain the output voltage sent from the voltage multiplier module with respect to the predetermined voltage level.

The reset circuit 15 provides a reset signal to the counter 17. In one example, the reset signal is kept at a logic low state if the regulated voltage from the regulator 14 does not reach the predetermined voltage level, and is transitioned to a logic high state once the regulated voltage reaches the predetermined voltage level. The transition of the reset signal “latches” the counter 17. That is, in response to a transition of the reset signal from logic low to logic high, the counter 17 provides a count having been counted since the clock signal is provided to the counter 17. In some examples, the counter 17 does not need to provide a count until the reset signal is transitioned from a logic high state to a logic low state. Since the time the regulated voltage reaches the predetermined voltage level is not certain, the time the counter 17 is latched and hence the count provided is not certain, either. The count serves as a random number (RN) of the random number generator 10, which may be used as an initial value, i.e., a seed number, for a pseudo random number generator. In one example, the random number RN has a 16-bit bandwidth, resulting in a 16-bit random number generator 10.

The initial value generator 16 provides an initial value to the counter 17, from which the random number RN is counted. The initial value is provided at substantially the time as the clock signal is provided to the counter 17. In one example, the initial value has a 16-bit bandwidth, resulting in a 16-bit random number generator 10. As a result, the count or the random number RN provided by the counter 17 is dependent on at least one of the frequency offset (F_{OFFSET}) due to the oscillator 12, the transition time (T_{RESET}) of the reset circuit 15, and the initial value (INIV) of the initial value generator 16, as may be derived from the mathematical function below.
RN=f(F_{OFFSET}, T_{RESET}, INIV)

Furthermore, the random number RN is indirectly dependent on the charging efficiency of the charge pump 13, the predetermined voltage level selected, and the process parameters or conditions regarding the manufacturing of the initial value generator 16. Therefore, the random number RN is not predictable.

FIG. 1B is a circuit diagram of a unit 16-1 of the initial value generator 16 illustrated in FIG. 1A for producing a random bit value. Referring to FIG. 1B, the unit 16-1 includes a capacitor labeled C, a p-type metal-oxide-semiconductor (“PMOS) transistor labeled P and an n-type metal-oxide-semiconductor (“NMOS”) transistor labeled N. The capacitor C includes one end (not numbered) connected to a voltage reference and the other end (not numbered) connected to the gates of the PMOS and NMOS transistor. The PMOS transistor P includes a source connected to a power supply labeled DC, and a drain where an output voltage V_{OUT} of the unit 16-1 is provided. The NMOS transistor N includes a drain connected to the drain of the PMOS transistor P and a source connected to the voltage reference. A voltage level V_{C} at the gates is dependent on the temperature of the capacitor C, the process parameters used in manufacturing the unit 16-1, or the residual charge in the capacitor C. The value of V_{C} therefore is not predictable. If V_{C} is negative enough to turn on the PMOS transistor P, the output voltage V_{OUT} is pulled to approximately the voltage level of the power supply DC such that the unit 16-1 provides a logic high value, i.e., logic 1. If V_{C} is positive enough to turn on the NMOS transistor N, the output voltage V_{OUT} is pulled to the voltage reference such that the unit 16-1 provides a logic low value, i.e., logic 0. Given an example of a 16-bit initial value generator 16, a total number of sixteen (16) units such as the unit 16-1 are required. Each of the sixteen units accounts for a bit value of the resultant initial value. Since the capacitor condition is different from unit to unit, the initial value provided by the initial value generator 16 is not predictable and, in other words, random.

FIG. 1C is a schematic timing diagram for the random number generator 10 illustrated in FIG. 1A. Referring to FIG. 1C, the oscillator 12 does not oscillate until time to, and provides the clock signal including a train of clocking pulses at the time t₀. The initial value generator 16 provides a random initial value K substantially at the same time t₀ since when the number of clocking pulses is counted from the initial value K. The counting continues till a transition of the reset signal occurs at time t_{N+1}. The counter 17 counts (K+N) at the time t_{N+1}, wherein N is the number of clocking pulses counted thus far. The value (K+N) serves as a random number and is then provided by the random number generator 10.

In some examples, the oscillator 12 may include a crystal oscillator, which allows a relatively low tolerance so that the effect on the resultant random number RN due to the frequency offset can be negated. For example, the oscillator 12 may provide the clock signal at a precise frequency of 10 MHz. The random number RN in the present example is expressed in a function below.
RN=g( F̅_̅{̅O̅F̅F̅S̅E̅T̅}̅, T_{RESET}, INIV)

In some examples, the time period to reset the counter 17 may be a constant, regardless of whether the output voltage from the regulator 14 equals the predetermined voltage level. For example, the counter 17 is reset once every second. The random number RN in the present example is expressed in the function below.
RN=h(F_{OFFSET}, T̅_̅{̅R̅E̅S̅E̅T̅}̅, INIV)

In one example, the initial value can be a predetermined value, for example, a full-zero or full-one output such that the effect on the resultant random number RN due to the randomness in each of the bits is negated. The random number RN in the present example is expressed in a function below.
RN=p(F_{OFFSET}, T_{RESET}, I̅N̅I̅V̅)

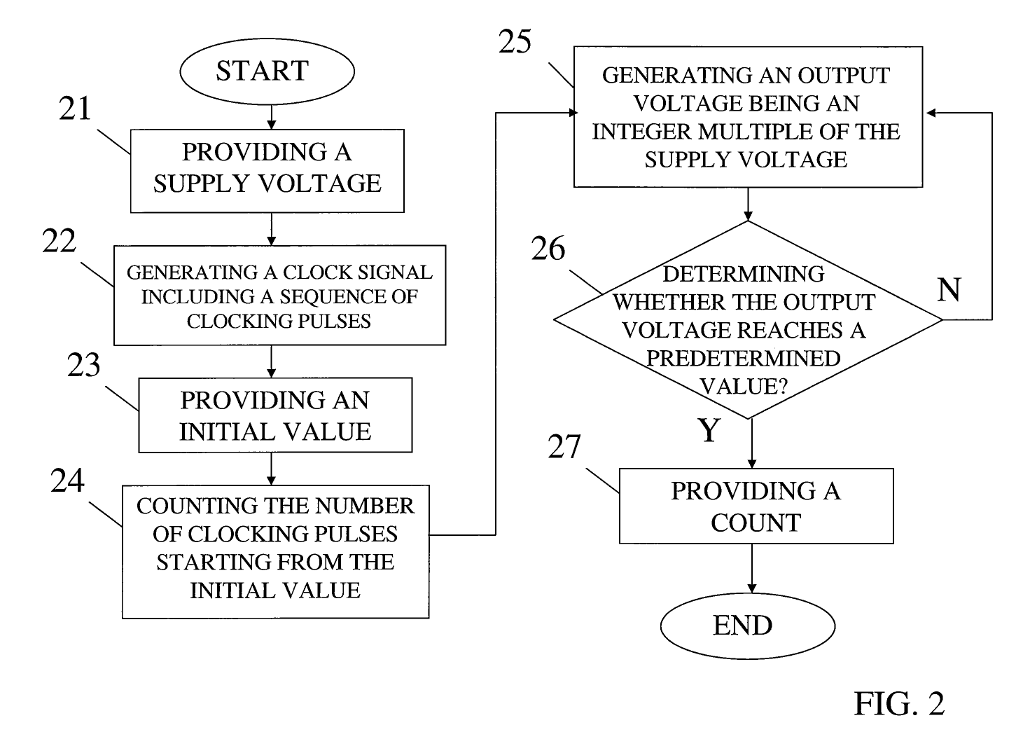

FIG. 2 is a flow diagram of a method for generating a random number consistent with an example of the invention. Referring to FIG. 2, at step 21, a supply voltage is provided. The supply voltage may include a DC voltage from a power supply such as a battery or a rectified DC voltage from a voltage rectifier rectifying an input alternating current (AC) voltage. At step 22, a clock signal including a sequence of clocking pulses is generated by, for example, an oscillator, which oscillates in response to the supply voltage. Next, an initial value is provided at step 23. The number of clocking pulses is counted from the initial value at step 24. An output voltage, which is an integer multiple of the supply voltage, is generated at step 25 by, for example, a charge pump circuit. The output voltage is compared with a predetermined voltage level at step 26 to determine whether the output voltage reaches the predetermined voltage level. If confirmative, a count is provided at step 27. The count is dependent on at least one of a frequency offset from a center frequency of the clock signal, the time the output voltage equals the predetermined voltage level, and the initial value.

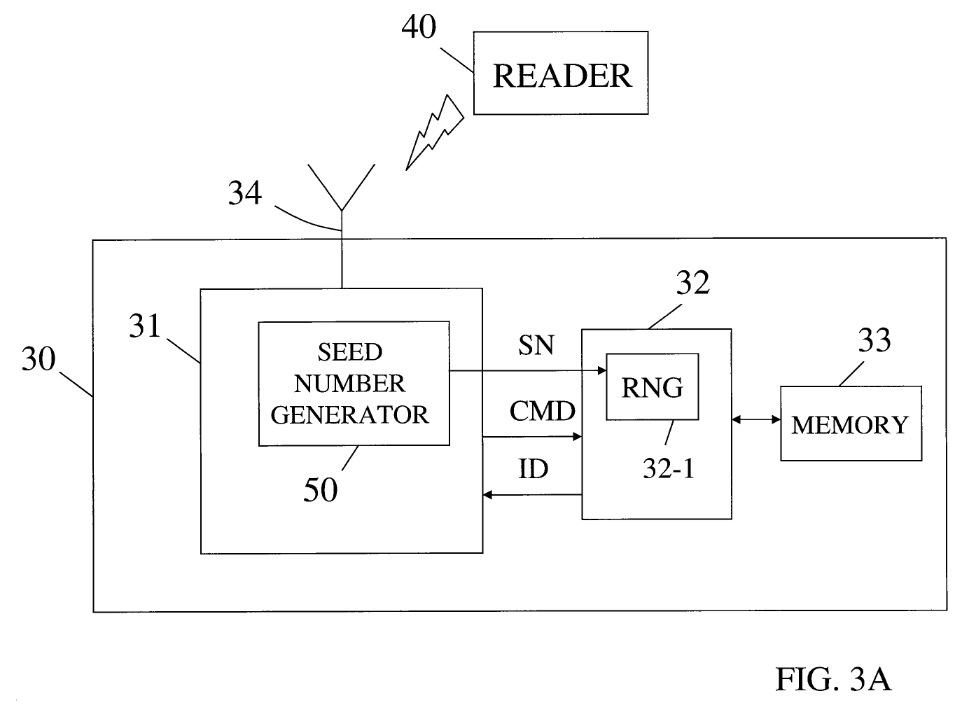

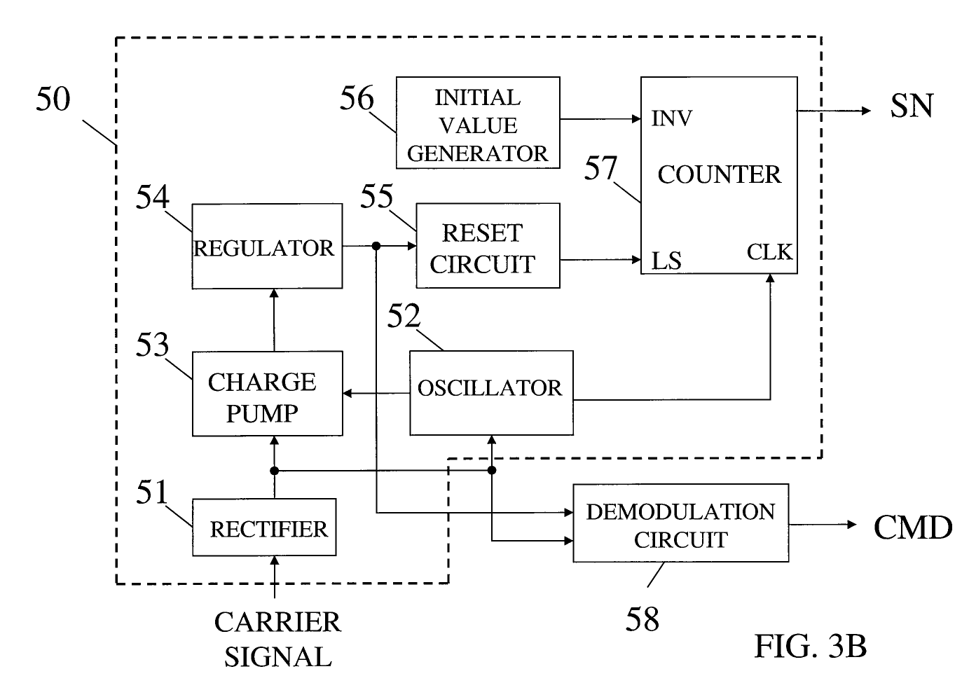

FIG. 3A is a schematic block diagram of a radio frequency identification (“RFID”) device 30 consistent with an example of the invention. Referring to FIG. 3A, the RFID device 30, which may be termed an RFID tag or a transponder, includes an analog module 31, a digital module 32 and a memory 33. The analog module 31 receives a carrier signal transmitted from a reader 40 through an antenna 34 such as a coiled antenna, and demodulates the carrier signal to obtain a command included in the carrier signal. The command generally requests the RFID device 30 to respond with identification (“ID”) information, which complies with the Electronic Product Code (“EPC”) standard. The ID information is stored in the memory 33 and may include the product name and price associated with a product item. The command is decoded by the digital module 32 before sent to the memory 33. The ID information provided by the memory 33 in response to the decoded command is encoded in the digital module 32, modulated in the analog module 31 and then transmitted to the reader 40 through the antenna 34.

In the RFID industry, the traffic between an RFID device and a reader may suffer from a phenomenon called “tag collision”, which may occur when plural RFID tags communicate with one reader at substantially the same time. A solution to solve the problem is to provided a random number generator in the RFID device for generating a random number. By distinguishing among the random numbers provided by the plural RFID devices, the reader is able to match a specific ID information with a specific random number at a specific time slot. However, as noted above, a conventional random number generator like a pseudo random number generator may often provide a number that is predictable and is not quite random. Consequently, the tag collision may not be alleviated.

Referring again to FIG. 3A, in one example, the RFID device 30 may further include a seed number generator 50 in the analog module 31 and a random number generator 32-1 in the digital module 32. The seed number generator 50 generates a seed number (SN), which is an unpredictable random number, to serve as an initial seed value for the random number generator 32-1. The random number generator 32-1, which may include a pseudo random number generator, generates a random number based on the seed number. Since the seed number is not predictable, the random number provided by the random number generator 32-1 is not predictable, either.

FIG. 3B is a block diagram of the seed number generator 50 of the RFID device 30 illustrated in FIG. 3A. Referring to FIG. 3B, the seed number generator 50 has a similar structure to the random number generator 10 illustrated in FIG. 1A except that a rectifier 51 replaces the power supply 11. The rectifier 51 receives the carrier signal transmitted from the reader 40 and obtains a DC voltage by rectifying the carrier signal. The DC voltage is provided to an oscillator 52 and a charge pump 53. Once oscillates, the oscillator provides a clock signal including a sequence of clocking pulses to the charge pump 53 and a counter 57. The clock signal has a frequency offset from a center frequency of the oscillator 52. In response to the cock signal, the charge pump 53 provides an output voltage which is an integer multiple of the DC voltage. The output voltage is regulated by a regulator 54 with respect to a predetermined voltage level. A reset circuit 55 latches the counter 57 once the output voltage reaches the predetermined voltage level. An initial value generator 56 provides an initial value to the counter 57 at substantially the same time the clock signal is provided to the counter 57. The seed number SN generated by the counter 57 is dependent on at least one of the frequency offset, the latch time and the initial value.

The RFID device 30 further includes a demodulation circuit 58 electrically connected to the rectifier 51 and the regulator 54 for providing the command (CMD). The seed number SN and the command CMD are sent to the digital module 32 illustrated in FIG. 3A.

It will be appreciated by those skilled in the art that changes could be made to one or more of the examples described above without departing from the broad inventive concept thereof. It is understood, therefore, that this invention is not limited to the particular examples disclosed, but it is intended to cover modifications within the scope of the present invention as defined by the appended claims.

Further, in describing certain illustrative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A random number circuit comprising:
an oscillator capable of generating a clock signal including a sequence of clocking pulses at a center frequency, the clock signal having a frequency offset from the center frequency;
a reset circuitry capable of generating a reset signal indicating a transition from a first state to a second state;
an initial value generator capable of generating an initial value; and
a counter coupled to at least one of the oscillator, the reset circuitry, and the initial value generator and capable of receiving at least one of the clock signal, the reset signal, and the initial value, the counter capable of generating a random number, the random number being dependent on at least one of the frequency offset, a timing of the transition, and the initial value.

2. The circuit of claim 1, wherein the oscillator includes one of a ring oscillator or a crystal oscillator.

3. The circuit of claim 1, further comprising a voltage multiplier for generating an output voltage that is an integer multiple of a supply voltage.

4. The circuit of claim 3, wherein the transition occurs when the output voltage reaches a predetermined voltage level.

5. The circuit of claim 1, wherein the counter counts the number of clocking pulses of the clock signal starting from the initial value.

6. The circuit of claim 5, wherein the counter resets a counting process in response to the transition.

7. The circuit of claim 1, wherein the initial value generator includes a plurality of units each of which corresponds to one of a plurality of bits of the initial value.

8. A random number circuit, comprising:
a device capable of providing a first voltage;
an oscillator capable of generating a clock signal including a sequence of clocking pulses at a center frequency, the clock signal having a frequency offset from the center frequency;
a charge pump capable of generating a second voltage being an integer multiple of the first voltage;
a reset circuitry capable of generating a reset signal, the reset signal transitioning from a first state to a second state once the second voltage reaches a predetermined voltage level;
an initial value generator capable of generating an initial value; and
a counter capable of counting the number of clocking pulses starting from the initial value in response to the clock signal, and generating a random number in response to the transitioning of the reset signal.

9. The circuit of claim 8, wherein the random number is dependent on at least one of the frequency offset, the transitioning of the reset signal, and the initial value.

10. The circuit of claim 8, wherein the device capable of providing the first voltage includes one of a battery or a rectifier.

11. The circuit of claim 8, wherein the oscillator generates the clock signal at a substantially constant frequency.

12. The circuit of claim 8, wherein the reset signal transitions from the first state to the second state at a substantially constant period.

13. The circuit of claim 8, wherein the initial value is a predetermined value.

14. The circuit of claim 8, wherein the initial value generator includes a plurality of units, each of the plurality of units further including a capacitor, a p-type transistor and an n-type transistor.

15. The circuit of claim 14, wherein each of the plurality of units accounts for one of a plurality of bits of the initial value.

16. A random number circuit, comprising:
a first random number generator capable of generating a first random number, comprising:
an oscillator capable of generating a clock signal including a sequence of clocking pulses;
a reset circuitry capable of generating a reset signal indicating a transition from a first state to a second state;
an initial value generator capable of generating an initial value; and
a counter capable of generating the first random number in response to the clock signal, the reset signal and the initial value; and
a second random number generator receiving the first random number capable of generating a second random number.

17. The circuit of claim 16, further comprising:
a device capable of generating a first voltage; and
a voltage multiplier capable of generating a second voltage being an integer multiple of the first voltage.

18. The circuit of claim 17, wherein the device includes one of a battery or a rectifier.

19. The circuit of claim 18, wherein the rectifier receives a carrier signal.

20. The circuit of claim 19, wherein the counter counts the number of clocking pulses starting from the initial value in response to the clock signal.

21. The circuit of claim 20, wherein the counter resets a counting process in response to the transition.

22. A method for generating a random number, comprising:
providing a first voltage;
generating a clock signal including a sequence of clocking pulses;
generating a second voltage being an integer multiple of the first voltage;
generating a reset signal including a first state and a second state;
transitioning the reset signal from one of the first and second states to the other of the first and second states once the second voltage reaches a predetermined voltage level;
generating an initial value; and
counting the number of clocking pulses starting from the initial value in response to the clock signal; and
generating the random number in response to the transitioning of the reset signal.

23. The method of claim 22, further comprising generating an initial value including a plurality of bits, each or the plurality of bits having a bit value independent of each other.

24. The method of claim 22, further comprising providing the first voltage from a direct current (DC) battery or by rectifying a carrier signal.

25. The method of claim 22, further comprising transitioning the reset signal at a substantially constant period.

26. The method of claim 22, further comprising generating an initial value having a predetermined value.

27. A method for generating a random number, comprising:
generating a clock signal including a sequence of clocking pulses;
generating a reset signal indicating a transition from a first state to a second state;
generating an initial value;
generating a first random number in response to the clock signal, the reset signal and the initial value; and
generating a second random number using the first random number as a seed number.

28. The method of claim 27, further comprising counting the number of clocking pulses starting from the initial value in response to the clock signal.

29. The method of claim 28, further comprising resetting a counting process in response to the transition.

30. The method of claim 27, further comprising generating an initial value including a plurality of bits, each or the plurality of bits having a bit value independent of each other.
